(19) United States
(12) Patent Application Publication
(10) Pub. No.: US 2008/0302612 A1
(43) Pub. Date: Dec. 11, 2008

(54) Elevator Car with Fold-Away Shock Absorbing Legs, and the Corresponding Elevator

(76) Inventors: Frederic Beauchaud, Couillons (FR); Thomas Coquerelle, Douai (FR)

Correspondence Address: OTIS ELEVATOR COMPANY;INTELLECTUAL PROPERTY DEPARTMENT, 10 FARM SPRINGS, FARMINGTON, CT, 06032, US

(21) Appl. No.: 11/659,055

(22) PCT Filed: Nov. 30, 2004
(86) PCT No.: PCT/IB04/03947

§ 371 Date: Jan. 31, 2007

(51) Int. Cl. B66B 5/28

(52) U.S. Cl. 187/344

(57) ABSTRACT

The invention pertains to an Elevator car with a lower chassis (3) bearing the passenger platform (5) characterized in that said chassis (3) is provided with at least one rigid bottom shock absorbing leg (13) mounted so as to fold away under said chassis before being mounted in its service position.

This invention relates to an elevator car with fold-away shock absorbing legs, and to the corresponding elevator.

Elevators are known to be provided with a device to absorb possible shocks of the elevator car at the bottom of the shaft, which generally includes a rigid leg fixed in the middle of the shaft bottom surface, and a shock absorbing buffer located opposite thereto under the elevator car. However, such an arrangement requires drilling the shaft bottom to set up the rigid leg, which may create a risk of groundwater seepage into the shaft bottom and requires a lot of time and resources.

The invention aims at correcting these disadvantages and provides an elevator car with a lower chassis bearing the passenger platform, characterized in that said chassis is provided with at least one rigid bottom shock absorbing leg mounted so as to fold away under said chassis before being mounted in its service position.

Such an arrangement avoids mounting a shock absorbing leg at the bottom of the elevator shaft. In addition, since the leg can be folded away under the chassis, it can be factory assembled to the latter, packaged therewith and easily and quickly mounted into its service position.

The elevator car is advantageously provided with two fold-away shock absorbing legs mounted on the peripheral chassis frame and on two opposite sides of the car.

This arrangement avoids having to stiffen the central area of the chassis bearing the car platform, as is the case with conventional platform designs with a chassis having a rigid center and bearing a central bottom shock absorbing buffer.

The two shock absorbing legs are advantageously hinged on the lengthwise sides of the chassis frame and can be folded inwards under the chassis to be accommodated in a folded-away position close to the car platform before being mounted in the service position, and can be mounted upright rigidly under the chassis frame in a lower vertical service position.

Said two legs can be arranged and hinged in the same plane parallel to a median plane of the car platform and close thereto, with the legs being arranged prior to mounting for service in a fold-away position one over the other under the chassis and attached to each other to be packaged with the platform chassis, adding no volume to the latter, for instance with a tie ring.

Said two legs can be hinged each to the bottom vertical skirt on the lengthwise side of the platform chassis, being simply hinged to a higher point thereof and fixed to a lower point thereof.

These legs, which have a rectangular or square cross-section, are advantageously accommodated each in a retaining skirt that is open inwards and complementary within a hinging clearance, and attached to said car chassis bottom skirt. This retaining skirt may be a rigid profile with a U-shaped cross section. In addition, each leg is hinged to the retaining skirt at an upper level, e.g. by a through bolt forming a hinge axis, which allows the leg to be folded inwards to be packaged with the chassis and to be mounted in the vertical service position after rotating and to be fixed to the skirt at a lower level by at least one second through bolt.

Of course, each of the legs bears a shock-absorbing buffer at its lower end, although said buffer can also be attached to the ground in the shaft bottom, in the vertical projection area of the leg.

The invention also relates to an elevator with a car such as defined above, wherein the shaft bottom contains no upright shock-absorbing element for the car as is conventional, and which can also accommodate, as required, a rigid plate fixed to the cabin guides and forming a shock receiving element for the shock absorbing buffers of said legs if they accidentally impact on the plate.

The vertical projection of the legs on the shaft bottom is preferably marked and signaled to ensure safe access by the maintenance operator.

The invention shall now be illustrated by an exemplary embodiment, with reference to the appended drawings in which:

FIG. 1 is a view of the bottom car platform fitted with shock-absorbing legs that are folded away under the chassis.

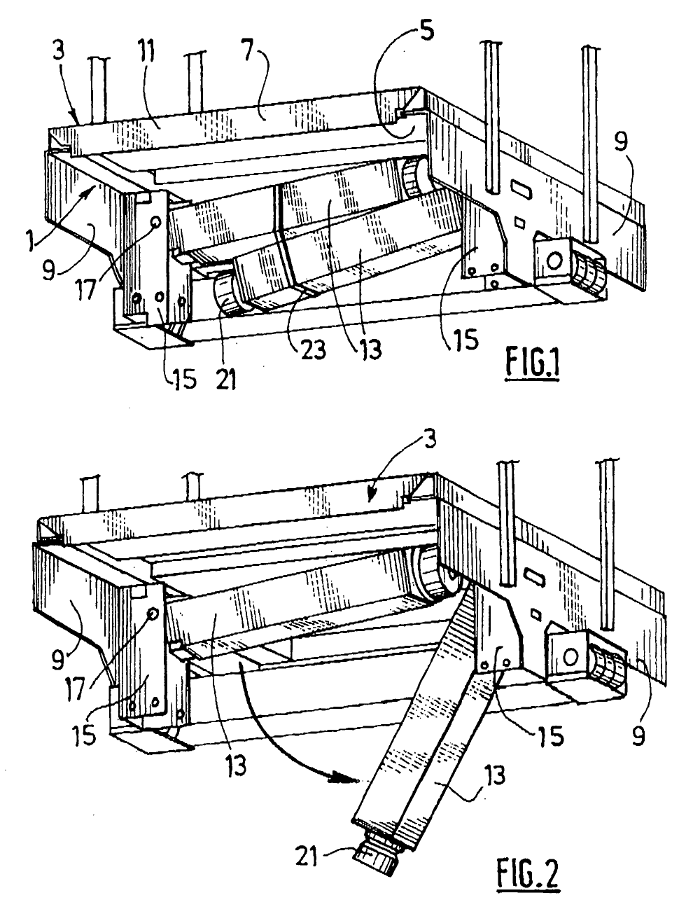

FIG. 2 is a view similar to FIG. 1 showing the extension of one of the shock-absorbing legs to be mounted in the service position.

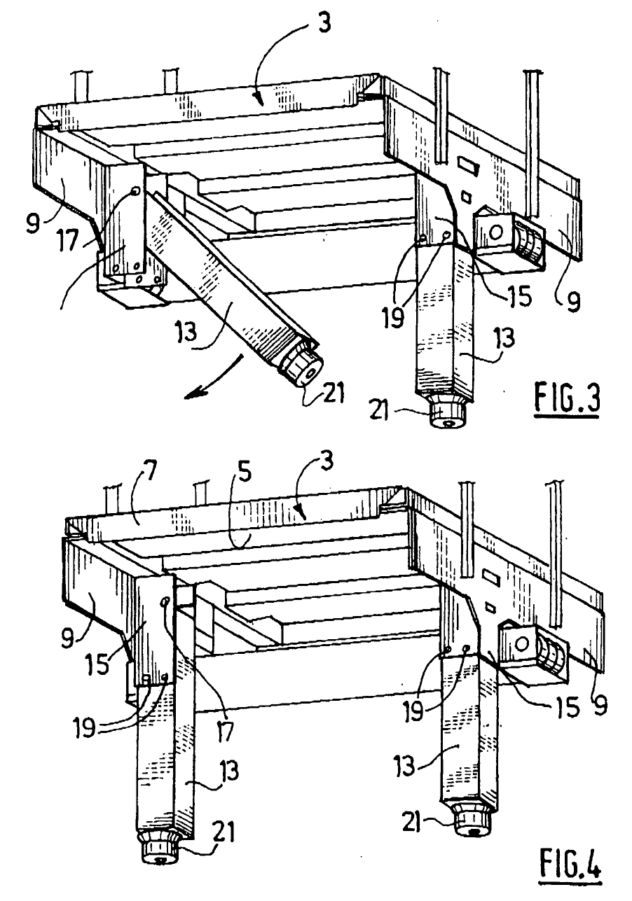

FIG. 3 shows the extension of the second shock-absorbing leg;

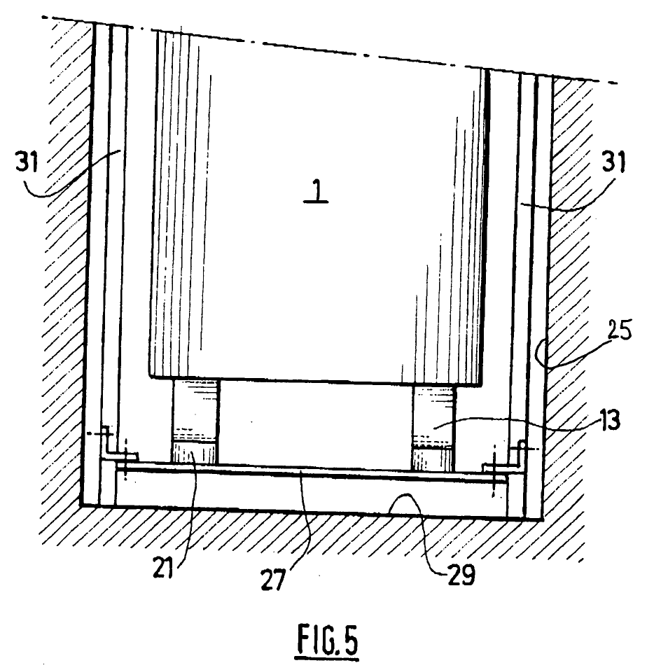

FIG. 4 shows the mounting in the service position of the shock-absorbing legs on the elevator car and

FIG. 5 is a partial elevation view of shaft bottom of an elevator in an alternative embodiment of the invention.

Referring to the figures, and particularly to FIG. 1, an elevator car 1 has been represented showing only its lower part, which is sufficient to understand the invention. The elevator car comprises a lower chassis 3 bearing the platform 5 that accommodates the passengers. The lower chassis 3 has a rigid metallic circumferential skirt 7 made of two higher opposite vertical flanks 9 on the lengthwise sides of the chassis and two lower opposite vertical flanks 11 on the widthwise sides of the chassis.

Two shock-absorbing legs 13 are arranged in a folded-away position below the chassis 3, close to the platform 5. These legs 13 are designed to buffer an accidental impact of the elevator car on the shaft bottom when mounted vertically on the chassis, as will be seen hereafter. In this folded-away position, they advantageously allow packaging the lower chassis 3 and the legs 13 as one part, with the shock-absorbing legs 13 requiring no additional volume in the package that is formed e.g. with a heat-shrunk film.

The legs 13 are identical and rectangular. They are located each close to the middle of the lengthwise side of the car and at the same height on the car chassis 3. They are hinged in continuity with each other in the same plane parallel to the widthwise sides of the chassis and close to its middle part. They are each mounted on a U-shaped flat 15 open inwards, which is attached to the flank 9 of the vertical car chassis skirt. The hinge axis is made of a bolt 17 mounted through the flat 15 at the top thereof, parallel to the side and in the body of the leg 13. Each of the flats 15 is provided with two holes at its bottom for two other bolts 19 that are also inserted through the body of the leg 13 and on the flat 15 and allow fixing the leg 13 in the vertical service position (FIG. 4).

The legs 13 are each provided with a shock-absorbing buffer 21 attached to the center of their lower end and made e.g. of a cylindrical rubber block with a low height and a diameter substantially equal to that of the cross-section side of the leg.

The buffers 21 are designed to be applied simultaneously on the shaft bottom (not represented) in case the elevator car impacts thereon, to provide a balanced absorption of the shock for the car on both legs.

The mounting of the legs 13 is now described. It consists in first breaking the package ring 23 tying the legs to each other in their folded-away position in the package, with the car hanging from a sling over the shaft bottom at man's height.

The lower leg 13 is turned manually as shown by the arrow on FIG. 2 until it stands vertically at the end of rotation and is retained by the back of the U-shaped flat 15. The two bolt shafts 19 just have to be passed through the lower holes of the flat and the leg, and then the corresponding nuts are tightened until the leg is completely and rigidly fixed to its retaining flat 15 (FIG. 3).

The second leg 13 is assembled in the same way by turning it as indicated by the arrow until it abuts on the back of its retaining flat 15, then attaching it to the flat 15 with the bottom bolts 19.

The mounting into the service position corresponding to FIG. 4 is then completed.

Of course, other embodiments of the invention can be obtained within the scope of the appended claims. For example, vertical telescopic legs can be provided instead of the hinged legs, and can be telescoped to a shorter length to be packaged with the platform chassis.

FIG. 5 is a partial elevation view of the bottom 29 of an elevator shaft 25 in an alternative elevator embodiment of the invention, in which the shock absorbing legs 13 do not come into contact with the shaft bottom 29 as previously but with a plate 27 attached horizontally to the car guide rails 31 and adjustable in height in order to set the acceptable overtravel of the car 1. This plate 27 can also be replaced by a single beam (not represented) attached by means of splice plates to the car guide rails 31, level with the shock absorbing legs 13. This arrangement allows adjusting the level of accommodation of the legs 13 independently from the shaft bottom 29.

1-14. (canceled)

15. An elevator car comprising:
a lower chassis bearing a passenger platform,
wherein said chassis is provided with at least one rigid bottom shock absorbing leg, and
wherein each shock absorbing leg is mounted to the chassis in a manner that enables the leg to be moved between: (a) a folded-away position under said chassis; and (b) a service position.

16. The elevator car of claim 15, wherein the chassis is provided with two fold-away shock absorbing legs that are mounted on two opposite sides of the car.

17. The elevator car of claim 16, wherein the two shock absorbing legs are hinged on lengthwise sides of the chassis frame and are configured to be folded inwards under the chassis to be accommodated in the folded-away position close to the car platform before being moved into the service position, and wherein the two shock absorbing legs are configured to be moved into, and rigidly fixed in, the service position in which the legs are uprightly oriented relative to the platform.

18. The elevator car of claim 16, wherein each of the two shock absorbing legs is hinged to a bottom vertical skirt of the chassis on a lengthwise side of the chassis.

19. The elevator car of claim 18, wherein each of the two shock absorbing legs is hinged to the bottom vertical skirt of the chassis at a first point that is provided away from a second point at which the legs are configured to be fixed in the service position.

20. The elevator car of claim 18, wherein each of the legs is accommodated in a respective retaining skirt, and wherein the retaining skirts are attached to the bottom skirt and open towards the inside of the chassis.

21. The elevator car of claim 20, wherein the retaining skirts have U-shaped cross sections that open inwards.

22. The elevator car of claim 16, wherein at least one of the shock absorbing legs has telescoping leg parts that enable the leg to be shortened when in the folded-away position and extended when moved into the service position.

23. The elevator car of claim 15, wherein each of the legs is configured to bear a shock-absorbing buffer at its lower end.

24. The elevator car of claim 23, wherein, when each of the legs bears a shock-absorbing buffer, the buffers are configured to impact substantially simultaneously a bottom surface of an elevator shaft, to provide a balanced absorption of a shock associated with the impact.

25. An elevator system comprising:
a shaft that has a bottom; and
an elevator car that is configured to move in the shaft towards and away from the shaft bottom, the car comprising a lower chassis bearing a passenger platform,
wherein the chassis is provided with at least one rigid bottom shock absorbing leg,
wherein each shock absorbing leg is mounted to the chassis in a manner that enables the leg to be moved between: (a) a folded-away position under said chassis; and (b) a service position,
wherein each of the legs bears a shock-absorbing buffer at its lower end,
wherein the buffers are configured to impact substantially simultaneously the shaft bottom, to provide a balanced absorption of a shock associated with the impact, and
wherein the shaft bottom contains no central upright shock absorbing element for the car.

26. The elevator system of claim 25, further comprising:
guide rails on which the car is configured to move towards and away from the shaft bottom,
wherein the shaft bottom contains a rigid plate fixed to the guide rails, and
wherein the rigid plate forms a shock receiving element for the shock absorbing buffers of said legs if they accidentally impact the plate.

27. The elevator system of claim 25, wherein a projection of where the legs will impact the shaft bottom is marked on the shaft bottom.
